(19) United States
(12) Patent Application Publication
(10) Pub. No.: US 2019/0047496 A1
(43) Pub. Date: Feb. 14, 2019

(54) EXTERNAL POWER SUPPLY FOR AN ELECTRIC VEHICLE

(71) Applicant: Faraday&Future Inc., Gardena, CA (US)

(72) Inventors: Daniel Arnold Sufrin-Disler, Toronto (CA); Phillip John Weicker, Los Angeles, CA (US)

(21) Appl. No.: 15/721,357

(22) Filed: Sep. 29, 2017

Related U.S. Application Data
(60) Provisional application No. 62/402,701, filed on Sep. 30, 2016.

(51) Int. Cl. B60R 16/033; B60L 11/18; B60D 1/64; H02J 7/00

(52) U.S. Cl. CPC B60R 16/033; B60L 11/1816; H02J 7/0054; B60D 1/64; B60L 11/1812

(57) ABSTRACT

The present disclosure relates to devices, systems, and methods for providing electric power to low voltage systems of a vehicle. In some embodiments, a vehicle includes a low voltage battery pack and at least two systems configured to draw power from the low voltage battery pack. The at least two vehicle systems can be operable in a first mode while connected to the low voltage battery pack, and can be operable in a second mode while disconnected from the low voltage battery pack. The second mode may be utilized when the vehicle is connected to an external low voltage power source. The second mode may be a low power mode in which the at least two systems have reduced functionality or are prohibited from operating simultaneously.

### CROSS-REFERENCE TO RELATED APPLICATIONS

The present application is related to U.S. Patent Application No. 62/402,701, entitled “EXTERNAL POWER SUPPLY FOR AN ELECTRIC VEHICLE,” filed on Sep. 30, 2016, which is hereby expressly incorporated by reference in its entirety and for all purposes.

The present application is related to U.S. patent application Ser. No. 15/050,077, entitled “INTEGRATED TRAILER HITCH AND JUMP START SYSTEM,” filed on Feb. 22, 2016, which is hereby expressly incorporated by reference in its entirety and for all purposes.

### BACKGROUND

### Field

This disclosure relates to electric vehicle power systems, and more specifically to systems and methods for supplying power to low-voltage systems of an electric vehicle.

### Description of the Related Art

Electric vehicles may use a high voltage (e.g. 400 V) battery system to propel the vehicle. This may be referred to herein as a first battery. An electric vehicle may also include a low voltage battery system to power various other functions (e.g., lights, windows, and ignition). This may be referred to herein as a second battery. Electric vehicles may thus include a low voltage battery similar to the low voltage batteries found in conventional automobiles. The output from the first battery may be stepped down and used to charge the second battery.

### SUMMARY

The systems and methods of this disclosure each have several innovative aspects, no single one of which is solely responsible for its desirable attributes. Without limiting the scope as expressed by the claims that follow, its more prominent features will now be discussed briefly.

In one implementation, a low voltage battery pack may be disposed within a vehicle. The vehicle may also include an electrical connector capable of receiving a power supply from a source external to the vehicle. At least one low voltage load may be disposed within the vehicle. A circuit may be electrically coupled to the low voltage battery pack, the electrical connector, and the least one low voltage load. The circuit may be configured to selectively direct current from either the low voltage battery pack or the electrical connector to the at least one low voltage load.

In one implementation, a vehicle includes a low voltage battery pack, an electrical connector capable of receiving a power supply from a source external to the vehicle, an at least two vehicle systems configured to draw power from the low voltage battery pack or the electrical connector. The at least two vehicle systems may be operable in a first mode when connected to the low voltage battery pack. The at least two vehicle systems may be operable in a second mode when disconnected from the low voltage battery pack and connected to the electrical connector.

A method of externally powering two or more systems of a vehicle may include one or more of the following steps. The method may include detecting an external power source connected a vehicle. The method may include drawing power from the external power source to operate a first system of the vehicle. The method may include modifying a functionality of at least a second system of the vehicle while the first system of the vehicle is operating.

In one embodiment, a vehicle is described. The vehicle may include one or more electrically operated systems of a vehicle, a low voltage battery pack switchably connected to the one or more electrically operated systems, and external power circuitry switchably connected to the one or more electrically operated systems. The external power circuitry is configured to provide power to the one or more electrically operated systems from an external power source. The external power circuitry can include a trailer wiring connector. The external power circuitry can be configured to detect the connection of an external power source. The low voltage battery pack can be configured to disconnect from the one or more electrically operated systems based at least in part on the detection of an external power source by the external power circuitry. The external power circuitry can be configured to connect to the one or more electrically operated systems based at least in part on the detection of an external power source by the external power circuitry. The vehicle can further include a CAN bus, wherein the external power circuitry and the one or more electrically operated systems are configured to communicate via the CAN bus. The external power circuitry can be configured to send a message to the one or more electrically operated systems indicating that power is being provided from an external power source. The one or more electrically operated systems can be configured to communicate via the CAN bus to coordinate operation in a low power mode while disconnected from the low voltage battery pack. The one or more electrically operated systems can be configured to delay or cancel performance of a function based at least in part on a message received from a different one of the electrically operated systems via the CAN bus.

In another embodiment, a vehicle is described. The vehicle includes a low voltage battery pack and at least two vehicle systems configured to draw power from the low voltage battery pack. The at least two vehicle systems are operable in a first mode while connected to the low voltage battery pack, and the at least two vehicle systems are operable in a second mode while disconnected from the low voltage battery pack. The at least two vehicle systems can be configured to draw less power in the second mode than in the first mode. Operation in the second mode can include a method of preventing more than one of the at least two vehicle systems from operating simultaneously. At least one of the at least two vehicle systems can be configured to notify the other systems of the at least two vehicle systems before operating. At least one function of at least one of the vehicle systems can be prevented from operating in the second mode.

In another embodiment, a method of externally powering two or more systems of a vehicle is described. The method includes detecting an external power source connected to circuitry of a vehicle, drawing power from the external power source to operate a first system of the vehicle, and modifying a functionality of at least a second system of the vehicle while the first system of the vehicle is operating. The method can further include disconnecting a low voltage battery pack of the vehicle based at least in part on detecting the external power source. Modifying the functionality of at least the second system can include preventing at least the second system from operating while the first system is operating. Modifying the functionality of at least the second system can include delaying a function of the second system until a function of the first system is discontinued. The method can further include detecting a voltage provided by the external power source. Drawing power from the external power source can occur based at least in part on the detected voltage of the external power source.

### BRIEF DESCRIPTION OF THE DRAWINGS

The above-mentioned aspects, as well as other features, aspects, and advantages of the present technology will now be described in connection with various implementations, with reference to the accompanying drawings. The illustrated implementations are merely examples and are not intended to be limiting. Throughout the drawings, similar symbols typically identify similar components, unless context dictates otherwise.

FIG. 1 is a schematic view of an electric vehicle having a trailer wiring connector power system in accordance with an exemplary embodiment.

FIG. 2 is a schematic view of the electric vehicle of FIG. 1. As shown, the vehicle includes a trailer hitch and a trailer wiring connector.

FIG. 2a is an enlarged view of the trailer wiring connector of FIG. 2.

FIG. 3 is a block diagram depicting a CAN bus connected to an external power connector and various vehicle systems in accordance with an exemplary embodiment.

FIG. 4 is a flowchart depicting an example method of powering vehicle systems from an external power source in accordance with an exemplary embodiment.

### DETAILED DESCRIPTION OF THE PREFERRED EMBODIMENT

The following description is directed to certain implementations for the purpose of describing the innovative aspects of this disclosure. However, a person having ordinary skill in the art will readily recognize that the teachings herein can be applied in a multitude of different ways. The described implementations may be implemented in any vehicle or battery system.

Electric vehicles may include one or more high voltage batteries having significant energy storage capacity. Such batteries or battery systems may be configured to power, for example, the electric traction motors that propel the vehicle. In some implementations, in addition to powering the vehicle's propulsion motors, the high voltage batteries' output may also be stepped down using one or more DC-to-DC converters to power some or all of the other lower voltage vehicle systems. Such systems include, but are not limited to, the interior and exterior lights, power assisted braking, power steering, infotainment, navigation, audio systems, wireless internet, automobile diagnostic systems, power windows, door handles, and various other systems that require electricity. Vehicles may also include one or more low voltage batteries configured to power low voltage vehicle systems, either directly or through a DC-to-DC converter.

In some implementations, it may be desirable to operate one or more low voltage systems of an electric vehicle without engaging either a high voltage battery or a low voltage battery. For example, a fault or other malfunction may be present in one or more of a high voltage battery, a low voltage battery, or a DC-to-DC converter of the vehicle preventing one or both of the battery systems from providing power to low voltage vehicle systems. In another example, operation of low voltage vehicle systems may be desired while the high voltage and/or low voltage batteries are being charged and unable to provide power. In yet another example, it may be necessary or desirable to operate a low voltage system of a vehicle, such as a door lock or handle one or more lights, a computer diagnostic system within the vehicle, or the like, during repairs or otherwise, while the high voltage and/or low voltage batteries or DC-to-DC converters are removed or disconnected from the electrically operated systems of the vehicle. Accordingly, the external power systems and methods described herein allow certain vehicle systems and/or functions to be operable independent of a high voltage or low voltage battery system within the vehicle.

In some implementations, an electric vehicle may include a low voltage battery pack and a high voltage battery pack. The low voltage battery pack may power one or more low voltage loads while the high voltage battery pack powers one or more high voltage loads. In some aspects, when the low voltage battery pack and the high voltage battery pack are disconnected and/or de-energized, the electric vehicle may be powered by an external power supply. The external power supply may be a low voltage power supply from another electric vehicle, external battery, or traditional gasoline powered vehicle. The external power supply may be used to re-charge the low voltage battery and or supply power to one of more low voltage loads. In some aspects, the external power supply is coupled to the vehicle using a standard trailer hitch wiring connector. In some aspects, the amount of current that passes through the electrical connection that is coupled to the external power supply is monitored, controlled, and or limited. That is to say, it may be desirable to limit the amount of current passing through the electrical connection that is coupled to the external power supply to ensure that the electrical connection does not fail.

In some aspects, an external power supply may be used to at least partially re-charge the low voltage battery pack and, at the same time, supply power to one or more low voltage loads. In some aspects, circuitry can determine which low voltage loads are supplied powered by the external power supply. For example, low voltage loads may be ranked based on importance, user preference, or the like. Loads with a higher ranking may be preferentially supplied power. In some aspects, when, for example, the low voltage battery pack has sufficient charge, the external power supply may power one or more low voltage loads while the low voltage battery pack powers other low voltage loads.

In one example, an electric vehicle may experience a total electrical failure of both the low voltage and high voltage battery packs. That is to say, the electric vehicle may not have an accessible internal power supply. In such a state, no vehicle systems may be utilized. As such, in some aspects, the vehicle may be couplable to an external low voltage supply. Current from the external low voltage supply may be selectively routed to one or more low voltage systems such that the various low voltage systems may be powered. In this way, doors, windows, hoods, and/or trunks may be opened, emergency lights could be powered, and the vehicle's modem could be powered.

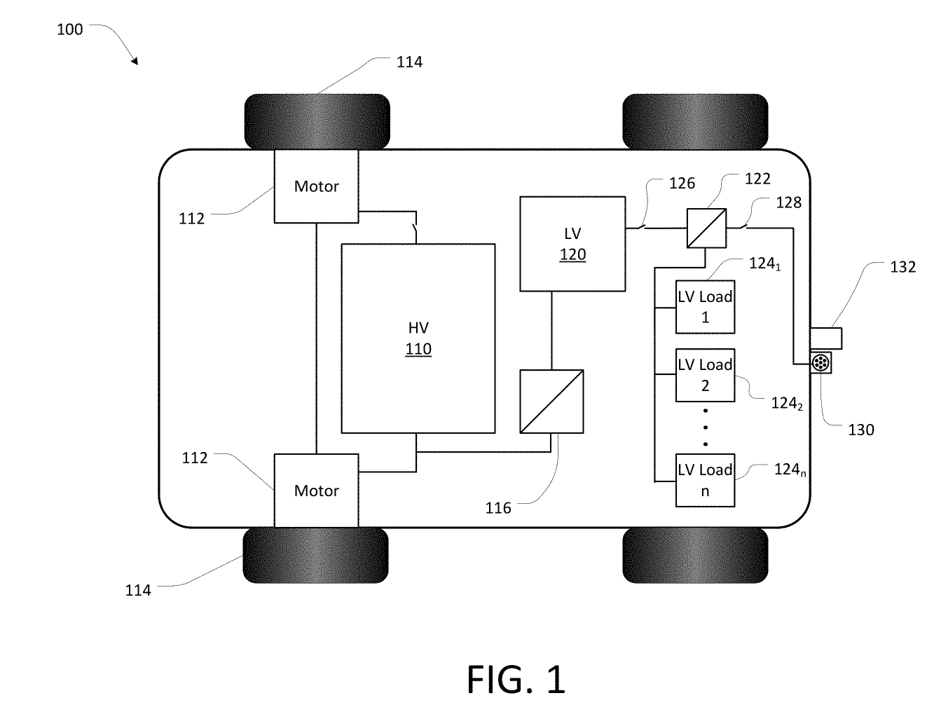

FIG. 1 is a simplified diagram depicting an electric vehicle 100 having a trailer wiring connector power system in accordance with an exemplary embodiment. The electric vehicle 100 includes a high voltage battery pack 110 and a low voltage battery back 120. The high voltage battery pack may be electrically connected to electric traction motors 112, which may be mechanically coupled to power the vehicle's drive wheels 114. The high voltage battery pack may be further connected to a high voltage DC-to-DC converter 116. A low voltage DC-to-DC converter 122 may be connected to the low voltage battery 120 and may be configured to provide low voltage power to various low voltage loads 124₁, 124₂, . . . 124ₙ. A trailer wiring connector 130 can be disposed adjacent to a trailer hitch 132, and may be electrically connected to some or all of the low voltage loads 124₁, 124₂, . . . 124ₙ.

During ordinary operation, the high voltage battery pack 110 may provide power to the motors 112 to turn the drive wheels 114 and propel the vehicle 100. Additionally, the high voltage battery pack 110 may send electric current to one or more high voltage DC-to-DC converters 116, which may be stepped down to a lower voltage. The low voltage may be sent to the low voltage battery 120 in order to recharge the low voltage battery 120 or routed to other low voltage systems.

The high voltage battery pack 110 typically has an energy storage capacity significantly larger than the capacity of the low voltage battery 120 and is capable of repeatedly recharging the low voltage battery 120. In some embodiments, the high voltage battery pack 110 may be connected to a plurality of high voltage DC-to-DC converters 116 to provide current at a variety of output voltages appropriate for powering various electrical systems of the vehicle 100. For example, powering exterior lights or an infotainment system may require a lower voltage than an electric braking assist system. In some embodiments, the various vehicle systems may be powered directly from high voltage DC-to-DC converters 116. In some embodiments, vehicle systems may be powered by the low voltage battery 120, either directly or through one or more low voltage DC-to-DC converters 122, while the low voltage battery 120 is continuously or intermittently recharged from the high voltage DC-to-DC converter 116. Like the high voltage battery pack 110, the low voltage battery 120 may be connected to one or a plurality of DC-to-DC converters 122 configured provide power at different output voltages based on the operating voltage requirements of the various low voltage loads 124₁, 124₂, . . . 124ₙ. The connection between low voltage battery pack 120 and low voltage DC-to-DC converter 122 may be switchable, such as by switch 126.

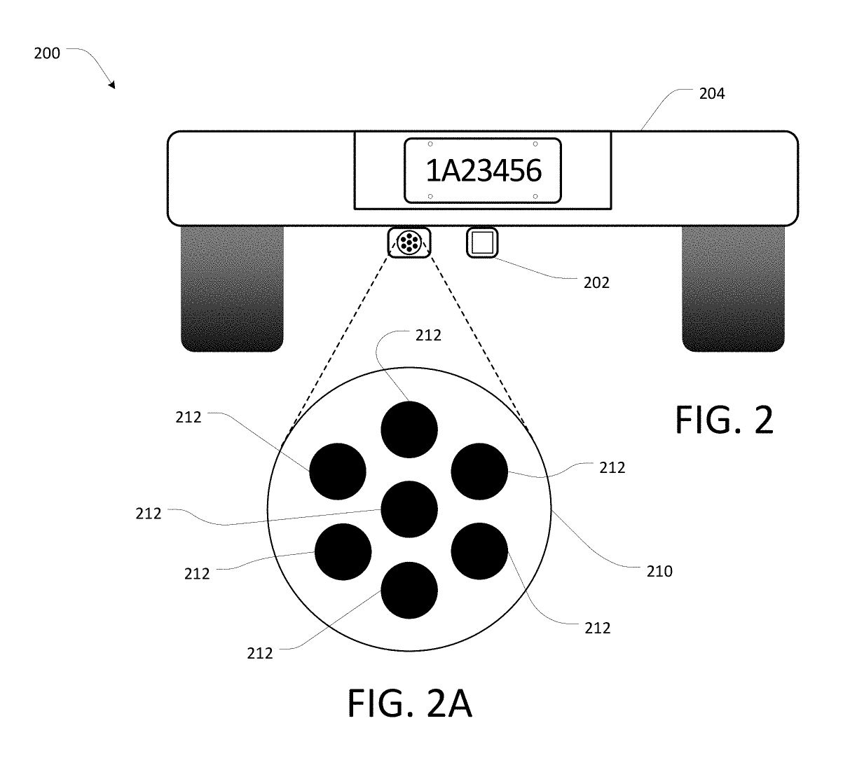

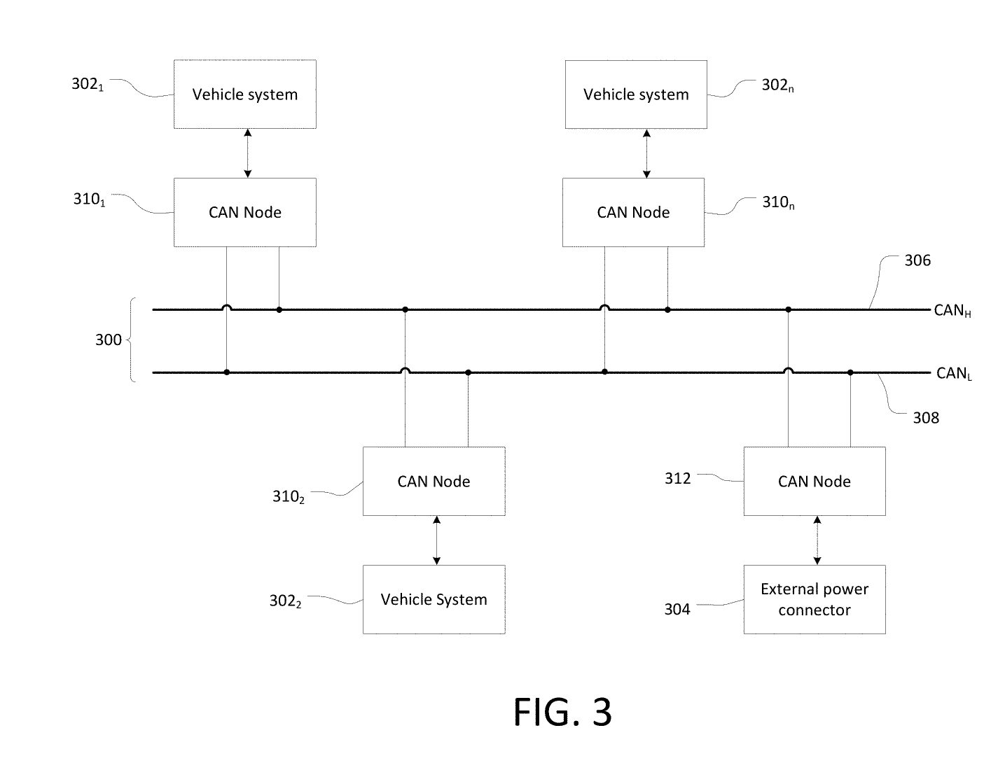

As will be described in greater detail below with reference to FIGS. 2 and 3, the vehicle 100 may have circuitry configured to allow the low voltage loads 124₁, 124₂, . . . 124ₙ to be powered from a current input at the trailer wiring connector 130 instead of by current drawn from the low voltage battery pack 120. A current input may be a DC current drawn from an external source such as the low voltage battery of another vehicle, or from any other source such as an AC/DC adapter. In various embodiments, the low voltage loads 124₁, 124₂, . . . 124ₙ may be configured to operate at a lower allowed total current while externally powered than when powered by the low voltage battery pack 120.

When a current source is connected to the electric vehicle 100 at the trailer wiring connector 130, the external power supply may be detected, such as by detecting a voltage drop between two contacts of the wiring connector 130. In some embodiments, the vehicle 100 may include circuitry (not shown) configured to further analyze the voltage input to verify that the external power supply is of an acceptable voltage. For example, the voltage may be acceptable if it is within a range ordinarily supplied by the low voltage battery pack, such as in the range of 8V-24V. Upon detecting a voltage and/or verifying an acceptable voltage of an external power supply, the wiring connector 130 may be connected to a low voltage DC-to-DC converter 122, such as by actuating switch 128. In various aspects, the low voltage loads 124₁, 124₂, . . . 124ₙ may be configured to operate in a low power mode while externally powered. For example, a low power mode may allow only certain of the low voltage loads 124₁, 124₂, . . . 124ₙ to operate, may require individual ones of the low voltage loads 124₁, 124₂, . . . 124ₙ to operate with limited functionality, and/or may limit the number of the low voltage loads 124₁, 124₂, . . . 124ₙ that may be operated simultaneously, such as 3, 2, or only 1 system at a time. Systems and methods for activation and operation of a low power mode are described in greater detail with reference to FIG. 3.

FIGS. 2 and 2A depict an external charge port arrangement of a battery jump start system in accordance with an exemplary embodiment. In some embodiments, a vehicle 200 may have a trailer hitch 202 secured on or near a rear bumper 204 and configured for towing trailers, other vehicles, or the like. A vehicle 200 with a trailer hitch 202 typically has a trailer wiring connector 210 located near the trailer hitch 202. Trailer wiring connectors 210 are well known in the art and available in several standard, commercially available configurations. Trailer wiring connectors allow for electrical connections between a towing vehicle and a trailer. A trailer wiring connector has a plurality of output pins 212 for powering the brakes and exterior lights of a trailer, as well as an output for providing auxiliary power to the trailer at roughly 12 volts. For example, a seven-pin trailer wiring connector 210 may have one ground pin, one 12 volt auxiliary power pin, one brake pin, and four pins providing power for the various lights of a trailer, such as brake lights, turn signals, reverse lights, and tail lights.

A standard trailer wiring connector 210 may serve as an external charge port for a battery jump start system in addition to serving as a power output for a trailer. The 12 volt auxiliary power pin of a trailer wiring connector 210 is generally used to provide 12 volt power from the tow vehicle 200 to power electrical systems of the trailer other than the trailer brakes and exterior lights. For example, current from the 12 volt auxiliary pin may power interior lights and/or appliances of a travel trailer. However, a pin 212 may also be wired to receive power from a charge source to charge the low voltage battery of the vehicle 200.

An adapter may be used to provide power from the charged battery of a second vehicle, or from another source, to the low voltage systems of vehicle 200. The adapter may include a standard trailer-side connector configured to plug into the trailer wiring connector 210. Rather than connecting all pins 212 of the wiring connector 210 to trailer systems, the adapter may connect only to the 12 volt auxiliary power pin and the ground pin of the connector 210. In some embodiments, the adaptor may include positive and negative alligator clips which may be connected to the terminals of the charged battery, allowing current to flow from the positive terminal of the charged battery to the 12 volt auxiliary power pin and from the negative terminal of the charged battery to the ground pin. In some embodiments, the adaptor may include a plug sized and shaped to draw power from the “cigarette lighter” 12 volt interior power socket of a vehicle, or a plug sized and shaped to draw power from an electric wall socket, combined with an AC-to-DC adapter. Thus, an adapter allows power to be drawn from a charged vehicle battery and delivered to the vehicle 200 through trailer wiring connector 210.

FIG. 3 is a block diagram depicting a CAN bus 300 and its connections to an external power connector 304 and various vehicle systems 302₁, 302₂, . . . 302ₙ, in accordance with an exemplary embodiment that may be used to implement a low power operating mode as described herein. CAN is a well-known system for vehicle communications and is commonly employed in various commercially available vehicles. Generally, a CAN bus 300 transmits data between various vehicle systems 302₁, 302₂, . . . 302ₙ through differential signaling, using a high-voltage line 306 and a low-voltage line 308 as a differential pair. Data may be transmitted to and received by vehicle systems 302₁, 302₂, . . . 302ₙ and/or external power connector 304 via a CAN node 310, 312. A CAN node may include circuitry including a transceiver configured to transmit messages from a vehicle system 302₁, 302₂, . . . 302ₙ or external power connector 304 to the CAN bus 300 and send messages received from the CAN bus 300 to a vehicle system 302₁, 302₂, . . . 302ₙ or external power connector 304.

Any number of vehicle systems 302₁, 302₂, . . . 302ₙ may communicate with a CAN bus 300. In some embodiments, ECUs may communicate through one or more CAN buses. In electric vehicles, a CAN bus may carry communications to and from high-voltage or other battery control systems. In some embodiments, a vehicle transmission, motor controller, power inverter, airbag control system, antilock brake system, cruise control, power steering, power windows, doors, audio systems, or any other system of a vehicle utilizing electronic communications may communicate via a CAN bus 300.

A low power mode may be implemented consistent with the vehicle described above with reference to FIGS. 1-2A, using CAN communications. As depicted in FIG. 3, the external power connector 304 and/or other detection or control circuitry connected to the external power connector 304 may be configured to communicate via a CAN bus 300 with any number of vehicle systems 302₁, 302₂, . . . 302ₙ. For example, the vehicle systems 302₁, 302₂, . . . 302ₙ may include the low voltage loads 124₁, 124₂, . . . 124ₙ described with reference to FIG. 1, such as vehicle door locks and/or opening mechanisms, interior lights, exterior lights, climate control, radio, infotainment, or the like.

An exemplary low power operating mode will now be described with reference to the CAN bus 300 and connected systems. When an external power source is detected at external power connector 304, a signal may be sent by CAN node 312 along the CAN bus 300 to the vehicle systems 302₁, 302₂, . . . 302ₙ via CAN nodes 310₁, 310₂, . . . 310ₙ, indicating that the systems 302₁, 302₂, . . . 302ₙ are to operate in the low power mode. The CAN signal may further include one or more operating parameters, permissions, or the like.

The vehicle systems 302₁, 302₂, . . . 302ₙ receiving the signal can then enter a low power operating mode based on information contained within the signal and/or preexisting information stored within one or more computer memory components of the vehicle systems 302₁, 302₂, . . . 302ₙ. For example, one or more of vehicle systems 302₁, 302₂, . . . 302ₙ may require too much power to be safely operable in a low power mode. Such systems may be deactivated by the low power mode signal, and may be prevented from operating until the low power mode is discontinued. In another example, one or more of vehicle systems 302₁, 302₂, . . . 302ₙ may have some functions that require too much power to be safely operable in a low power mode, but have other lower power functions that may be safely performed in a low power mode. Such systems may be configured to limit their functionality to only the lower power functions upon receiving the low power mode signal. The higher power functions may be disallowed until the low power mode is discontinued.

In another example, a low power mode may require time separation of the functions of the vehicle systems 302₁, 302₂, . . . 302ₙ so that two or more of the vehicle systems 302₁, 302₂, . . . 302ₙ cannot operate at the same time. In such implementations, one of the vehicle systems 302₁, 302₂, . . . 302ₙ may send a message via the CAN bus 300 to the other vehicle systems vehicle systems 302₁, 302₂, . . . 302ₙ indicating that it is to perform a function. Based on the message, the other vehicle systems vehicle systems 302₁, 302₂, . . . 302ₙ may be prevented from operating until the operating system sends a subsequent message via the CAN bus 300 indicating that it has completed the function. In some embodiments, additional control circuitry may be connected to the CAN bus 300 so as to govern the time-separated functioning of the vehicle systems 302₁, 302₂, . . . 302ₙ in accordance with the parameters of the low power operating mode.

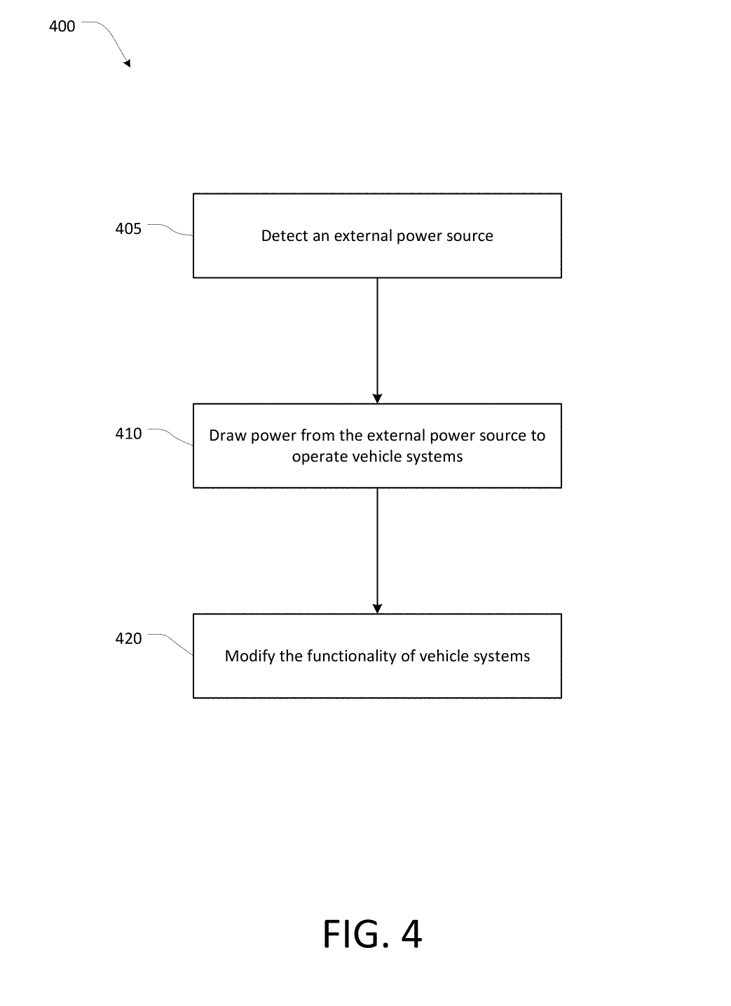

FIG. 4 is a flowchart depicting an example method 400 of powering vehicle systems from an external power source. The method 400 begins at block 405, where an external power source is detected at an external power connector of a vehicle. The external power source can be any external circuitry configured to deliver electric current to the vehicle. For example, the external power source can be a DC power source connected at a trailer wiring connector of the vehicle. The vehicle may detect the presence of the external power source by detecting a voltage difference, such as between a supply contact and a ground contact of a wiring connector, or any other voltage difference indicative of a supply of DC current. The detecting step may further include a voltage verification step, in which the voltage supplied by the external power source is detected, measured, and/or monitored to determine if the supplied voltage is within a desired range. For example, the range may be between 8 and 24 volts, between 12 and 16 volts, or any other appropriate range. The range may be determined based on operating characteristics and/or requirements of one or more vehicle systems, a DC-to-DC converter within the vehicle, or the like. After the external power source is detected, the method 400 continues to block 410.

At block 410, the vehicle draws power from the external power source to operate one or more low voltage electrically powered systems of the vehicle. Drawing power to operate vehicle systems may include any one or combination of the steps of disconnecting a low voltage battery pack of the vehicle from the low voltage vehicle systems and/or a DC-to-DC converter via a switch, connecting the circuitry receiving the external power supply to the low voltage systems and/or a DC-to-DC converter via a switch, activating one or more vehicle systems based on drawing a current from the external power supply, or other steps. One or more electrically powered vehicle systems can then be operated using current drawn from the external power source. After the vehicle draws power from the external power source to operate vehicle systems, the method 400 continues to block 420.

At block 420, the functionality of vehicle systems is modified while an external power source is being used. As described elsewhere herein, the modification of the functionality of vehicle systems can include implementing a time-separation of functions such that only one function can occur at a time, limiting certain systems to only a subset of their full functionality, or preventing certain systems from functioning entirely. For example, relatively high power systems that ordinarily draw power from the low voltage battery pack, such as an audio/visual infotainment system, may be deactivated entirely while the vehicle is operating in a low power mode using external power. A time-separated operation mode may include preventing or queueing simultaneously commanded functions. For example, while operating in a low power mode, two doors may be commanded to unlock electronically. In some embodiments, a first one of the two doors may be unlocked, while the command to the second door may be ignored. Alternatively, the command to the second door may be queued, and may be executed to unlock the second door after the first door has finished unlocking. Thus, the functionality of various systems of the vehicle may be modified so as to reduce the probability of drawing excessive current from the external power source. After the functionality of vehicle systems is modified, the method 400 terminates. In some embodiments, the modification of functionality may later be reversed upon a determination that the external power source has been disconnected and a low voltage battery pack has been connected to power the vehicle systems.

The foregoing description details certain embodiments of the systems, devices, and methods disclosed herein. It will be appreciated, however, that no matter how detailed the foregoing appears in text, the devices and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated. The scope of the disclosure should therefore be construed in accordance with the appended claims and any equivalents thereof.

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

It is noted that the examples may be described as a process. Although the operations may be described as a sequential process, many of the operations can be performed in parallel, or concurrently, and the process can be repeated. In addition, the order of the operations may be rearranged. A process is terminated when its operations are completed. A process may correspond to a method, a function, a procedure, a subroutine, a subprogram, etc.

The previous description of the disclosed implementations is provided to enable any person skilled in the art to make or use the present disclosed process and system. Various modifications to these implementations will be readily apparent to those skilled in the art, and the generic principles defined herein may be applied to other implementations without departing from the spirit or scope of the disclosed process and system. Thus, the present disclosed process and system is not intended to be limited to the implementations shown herein but is to be accorded the widest scope consistent with the principles and novel features disclosed herein.

What is claimed is:

1. A vehicle comprising:
a low voltage battery pack disposed within the vehicle;
an electrical connector capable of receiving a power supply from a source external to the vehicle;
at least one low voltage load disposed within the vehicle; and
a circuit electrically coupled to the low voltage battery pack, the electrical connector, and the least one low voltage load, the circuit configured to selectively direct current from either the low voltage battery pack or the electrical connector to the at least one low voltage load.

2. The vehicle of claim 1, wherein the electrical connector comprises a trailer hitch wiring connector.

3. The vehicle of claim 1, wherein the circuit is configured to detect when an external power source is coupled to the electrical connector.

4. The vehicle of claim 3, wherein the circuit is configured to direct current from the electrical connector at least in part on the detection of the external power source.

5. The vehicle of claim 3, wherein the circuit is configured to direct current from the low voltage battery pack at least in part on an absence of the detection of the external power source.

6. The vehicle of claim 1, further comprising a CAN bus, wherein the electrical connector and the at least one low voltage load are configured to communicate via the CAN bus.

7. The vehicle of claim 6, wherein the electrical connector is configured to send a message to the at least one low voltage load indicating that power is being provided from an external power source.

8. The vehicle of claim 6, wherein the at least one low voltage load comprises a plurality of low voltage systems, the low voltage systems configured to communicate via the CAN bus to coordinate current draw among low voltage systems when disconnected from the low voltage battery pack.

9. The vehicle of claim 8, wherein the plurality of low voltage systems are configured to delay or cancel performance of a function based at least in part on a message received via the CAN bus.

10. A vehicle comprising:
a low voltage battery pack;
an electrical connector capable of receiving a power supply from a source external to the vehicle; and
at least two vehicle systems configured to draw power from the low voltage battery pack or the electrical connector,
wherein the at least two vehicle systems are operable in a first mode when connected to the low voltage battery pack, and wherein the at least two vehicle systems are operable in a second mode when disconnected from the low voltage battery pack and connected to the electrical connector.

11. The vehicle of claim 10, wherein the at least two vehicle systems are configured to draw less power in the second mode than in the first mode.

12. The vehicle of claim 10, wherein operation in the second mode includes preventing more than one of the at least two vehicle systems from operating simultaneously.

13. The vehicle of claim 12, wherein at least one of the at least two vehicle systems is configured to notify the other systems of the at least two vehicle systems before operating.

14. The vehicle of claim 10, wherein at least one function of at least one of the vehicle systems is prevented from operating in the second mode.

15. A method of externally powering two or more systems of a vehicle, the method comprising:
detecting an external power source connected a vehicle;
drawing power from the external power source to operate a first system of the vehicle; and
modifying a functionality of at least a second system of the vehicle while the first system of the vehicle is operating.

16. The method of claim 15, further comprising disconnecting a low voltage battery pack of the vehicle based at least in part on detecting the external power source.

17. The method of claim 15, wherein modifying the functionality of at least the second system comprises preventing at least the second system from operating while the first system is operating.

18. The method of claim 15, wherein modifying the functionality of at least the second system comprises delaying a function of the second system until a function of the first system is discontinued.

19. The method of claim 15, further comprising detecting a voltage provided by the external power source.

20. The method of claim 19, wherein drawing power from the external power source occurs based at least in part on the detected voltage of the external power source.
